(19) United States
(12) Patent Application Publication
(10) Pub. No.: US 2023/0280169 A1
(43) Pub. Date: Sep. 7, 2023

(54) INFORMATION PROCESSING APPARATUS, NON-TRANSITORY COMPUTER READABLE MEDIUM, AND INFORMATION PROCESSING METHOD

(71) Applicant: TOYOTA JIDOSHA KABUSHIKI KAISHA, Toyota-shi Aichi-ken (JP)

(72) Inventors: Ibuki Shimada, Miyoshi-shi Aichi-ken (JP); Toshiki Kashiwakura, Tokyo-to (JP); Hiromitsu Urano, Numazu-shi (JP); Daichi Hotta, Meguro-ku Tokyo-to (JP)

(73) Assignee: TOYOTA JIDOSHA KABUSHIKI KAISHA, Toyota-shi Aichi-ken (JP)

(21) Appl. No.: 18/116,082

(22) Filed: Mar. 1, 2023

(30) Foreign Application Priority Data
Mar. 3, 2022 (JP) 2022-033008

(51) Int. Cl. G01C 21/34

(52) U.S. Cl. CPC G01C 21/3438; G01C 21/343

(57) ABSTRACT

In an information processing apparatus including a controller, the controller is configured to execute operations including accepting designation of a reserved stop as a stop for a vehicle, determining a stop other than the reserved stop as a standby stop when it is determined that the reserved stop is to be used by another vehicle at a scheduled arrival time at the reserved stop, and notifying a passenger of the vehicle that the vehicle is stopping at the standby stop.

### CROSS-REFERENCE TO RELATED APPLICATION

This application claims priority to Japanese Patent Application No. 2022-033008, filed on Mar. 3, 2022, the entire contents of which are incorporated herein by reference.

### TECHNICAL FIELD

The present disclosure relates to an information processing apparatus, a program, and an information processing method.

### BACKGROUND

Technology for transmitting information on a location designated by a driver of a community bus 20 operating on demand, as a location that is easy to pick up a user 10, to a terminal of the user 10 along with an image is known (for example, Patent Literature (PTL) 1). At this time, the pickup location is set as a “virtual stop”.

### CITATION LIST

### Patent Literature

PTL 1: JP 2018-147282 A

### SUMMARY

The above conventional technology does not take into account cases in which bus stops are congested. In these cases, buses cannot park at the bus stops and passengers have to wait on the streets until the congestion is cleared. This hinders the traffic of other vehicles. Furthermore, service convenience is reduced due to inability to let the passengers get on and off.

It would be helpful to provide an information processing apparatus, a program, and an information processing method capable of smoothing traffic and improving service convenience.

An information processing apparatus according to an embodiment of the present disclosure is an information processing apparatus including a controller configured to execute operations, the operations including:

accepting designation of a reserved stop as a stop for a vehicle;

determining a stop other than the reserved stop as a standby stop when it is determined that the reserved stop is to be used by another vehicle at a scheduled arrival time at the reserved stop; and

notifying a passenger of the vehicle that the vehicle is stopping at the standby stop.

A program according to an embodiment of the present disclosure is configured to cause a computer, as an information processing apparatus, to execute operations, the operations including:

accepting designation of a reserved stop as a stop for a vehicle;

determining a stop other than the reserved stop as a standby stop when it is determined that the reserved stop is to be used by another vehicle at a scheduled arrival time at the reserved stop; and

notifying a passenger of the vehicle that the vehicle is stopping at the standby stop.

An information processing method according to an embodiment of the present disclosure is an information processing method performed by an information processing apparatus, the information processing method including:

accepting designation of a reserved stop as a stop for a vehicle;

determining a stop other than the reserved stop as a standby stop when it is determined that the reserved stop is to be used by another vehicle at a scheduled arrival time at the reserved stop; and

notifying a passenger of the vehicle that the vehicle is stopping at the standby stop.

According to the information processing apparatus, program, and information processing method according to one embodiment of the present disclosure, it is possible to smooth traffic and improve service convenience.

### BRIEF DESCRIPTION OF THE DRAWINGS

In the accompanying drawings:

FIG. 1 is a schematic diagram of an information processing system according to the present embodiment;

FIG. 2 is a block diagram illustrating a configuration of an information processing apparatus;

FIG. 3 is a block diagram illustrating a configuration of a vehicle;

FIG. 4 is a block diagram illustrating a configuration of a user terminal;

FIG. 5 is a flowchart illustrating operations of the information processing apparatus;

FIG. 6 is a diagram illustrating a data structure of a scheduled arrival time database (DB);

FIG. 7 is a drawing illustrating a reserved stop;

FIG. 8 is a diagram illustrating a standby stop;

FIG. 9 is a drawing illustrating an example of an alternative stop; and

FIG. 10 is a drawing illustrating another example of the alternative stop.

### DETAILED DESCRIPTION

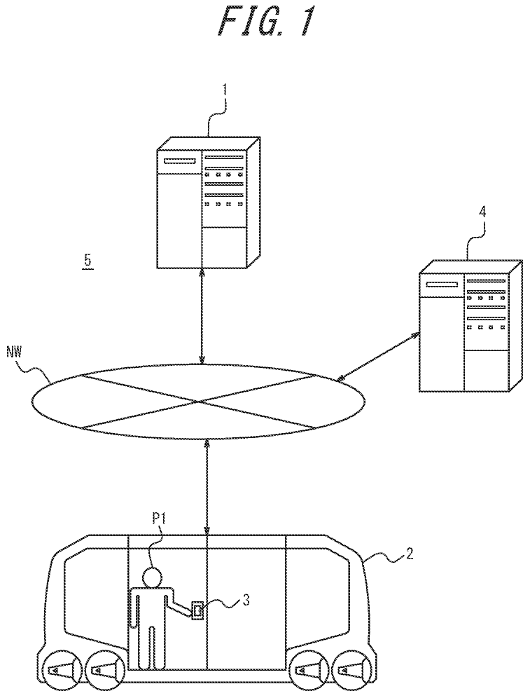

FIG. 1 is a schematic diagram of an information processing system S according to the present embodiment. The information processing system S includes an information processing apparatus 1, a vehicle 2, a user terminal 3, and a second information processing apparatus 4. A user P1 gets on the vehicle 2. The user P1 operates the user terminal 3. The information processing apparatus 1 can communicate with the vehicle 2, the user terminal 3, and the second information processing apparatus 4 via a network NW. The network NW includes, for example, a mobile communication network or the Internet.

FIG. 1 illustrates one of the information processing apparatus 1 for convenience of explanation. However, the number of information processing apparatuses 1 is not limited to this. For example, processing to be executed by the information processing apparatus 1 may be executed by a plurality of distributed information processing apparatuses 1.

An outline of processing to be executed by the information processing apparatus 1 according to the present embodiment will be described. A controller 11 of the information processing apparatus 1 is configured to execute operations that include accepting designation of a reserved stop C as a stop for the vehicle 2, determining a stop other than the reserved stop C as a standby stop B when it is determined that the reserved stop C is to be used by another vehicle at a scheduled arrival time at the reserved stop C, and notifying a passenger of the vehicle 2 that the vehicle 2 is stopping at the standby stop B. According to this configuration, the information processing apparatus 1 allows the vehicle 2 to avoid stopping at the reserved stop C when the reserved stop C is congested, thus smoothing traffic. The information processing apparatus 1 also allows the passenger to get off at the standby stop B, thus improving service convenience.

The information processing apparatus 1 may be a server configured to assist a provider in providing a service. The information processing apparatus 1 is, for example, an on-demand bus operation management server. The information processing apparatus 1 may have the function of accepting and managing passenger reservations and the function of managing bus operation plans. The information processing apparatus 1 may be, for example, installed in a facility dedicated to the provider or in a shared facility including a data center. As an alternative example, the information processing apparatus 1 may be mounted in the vehicle 2.

The vehicle 2 includes, for example, any type of automobile such as a gasoline vehicle, a diesel vehicle, an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. The driving of the vehicle 2 may be automated at any level. The automation level is, for example, any one of Level 1 to Level 5 according to the level classification defined by SAE. The name “SAE” is an abbreviation of Society of Automotive Engineers. The vehicle 2 may be a MaaS-dedicated vehicle. The term “MaaS” is an abbreviation of Mobility as a Service. Alternatively, the vehicle 2 may be driven by a driver.

The user terminal 3 is a terminal to be operated by the user P1. The user terminal 3 is, for example, a mobile device such as a mobile phone, a smartphone, a wearable device, or a tablet. As an alternative example, the user terminal 3 may be a general purpose device such as a PC, or a dedicated device. The term “PC” is an abbreviation of personal computer.

The second information processing apparatus 4 is an information processing apparatus different from the information processing apparatus 1. When the information processing apparatus 1 is an on-demand bus operation management server, the second information processing apparatus 4 may be, for example, a city infrastructure management server that manages parking spaces or congestion of on-demand buses, or a server that manages vehicles other than the on-demand buses.

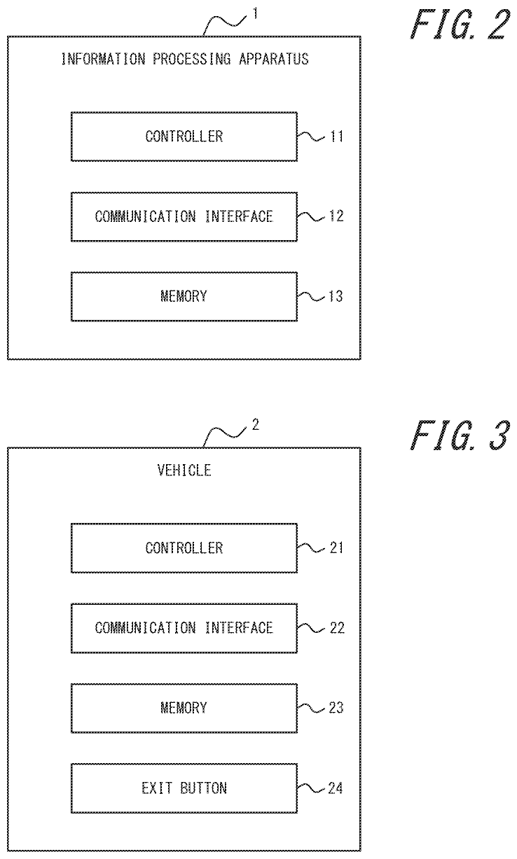

With reference to FIG. 2, an internal configuration of the information processing apparatus 1 will be described in detail.

The information processing apparatus 1 includes the controller 11, a communication interface 12, and a memory 13. The components of the information processing apparatus 1 are communicably connected to one another, for example, via dedicated lines.

The controller 11 includes, for example, one or more general purpose processors including a Central Processing Unit (CPU) or a Micro Processing Unit (MPU). The controller 11 may include one or more dedicated processors that are dedicated to specific processing. The controller 11 may include one or more dedicated circuits instead of the processors. Examples of the dedicated circuits may include a Field-Programmable Gate Array (FPGA) and an Application Specific Integrated Circuit (ASIC). The controller 11 may include an Electronic Control Unit (ECU).

The communication interface 12 includes, for connecting to a network, one or more communication modules that conform to wired or wireless Local Area Network (LAN) standards. The communication interface 12 may include a module conforming to one or more mobile communication standards including the Long Term Evolution (LTE) standard, the 4th Generation (4G) standard, or the 5th Generation (5G) standard. The communication interface 12 may include one or more communication modules conforming to near field communication standards or specifications, including Bluetooth® (Bluetooth is a registered trademark in Japan, other countries, or both), AirDrop® (AirDrop is a registered trademark in Japan, other countries, or both), IrDA, ZigBee® (ZigBee is a registered trademark in Japan, other countries, or both), Felica® (Felica is a registered trademark in Japan, other countries, or both), or RFID. The communication interface 12 transmits and receives any information via the network.

The memory 13 includes, for example, a semiconductor memory, a magnetic memory, an optical memory, or a combination of at least two of these, but is not limited to these. The semiconductor memory is, for example, RAM or ROM. The RAM is, for example, SRAM or DRAM. The ROM is, for example, EEPROM. The memory 13 may function as, for example, a main memory, an auxiliary memory, or a cache memory. The memory 13 may store information resulting from analysis or processing performed by the controller 11. The memory 13 may store various types of information or the like regarding operations or control of the information processing apparatus 1. The memory 13 may store a system program, an application program, embedded software, and the like. The memory 13 may be provided outside the information processing apparatus 1 and accessed by the information processing apparatus 1. The memory 13 may include a scheduled arrival time DB, which is described below.

With reference to FIG. 3, an internal configuration of the vehicle 2 will be described in detail.

The vehicle 2 includes a controller 21, a communication interface 22, a memory 23, and an exit button 24. The exit button 24 is optional. The components of the vehicle 2 are communicably connected to one another, for example, via dedicated lines.

The controller 21 may include an automatic driving kit. The controller 21 can acquire positional information on the vehicle 2 via a positional information sensor.

The positional information sensor includes at least one GNSS receiver. The term “GNSS” is an abbreviation of Global Navigation Satellite System. GNSS includes, for example, GPS, QZSS, BeiDou, GLONASS, and/or Galileo. The term “GPS” is an abbreviation of Global Positioning System. The term “QZSS” is an abbreviation of Quasi-Zenith Satellite System. QZSS satellites are called quasi-zenith satellites. The term “GLONASS” is an abbreviation of Global Navigation Satellite System. The “positional information” is information that can identify the position of the vehicle 2, and includes, for example, coordinates.

The hardware configurations of the controller 21, the communication interface 22, and the memory 23 of the vehicle 2 may be the same as those of the controller 11, the communication interface 12, and the memory 13 of the information processing apparatus 1, respectively. An explanation here is omitted.

The exit button 24 is a button that a passenger of the vehicle 2 presses to notify a driver or manager of the vehicle 2 that the passenger is getting off the vehicle 2.

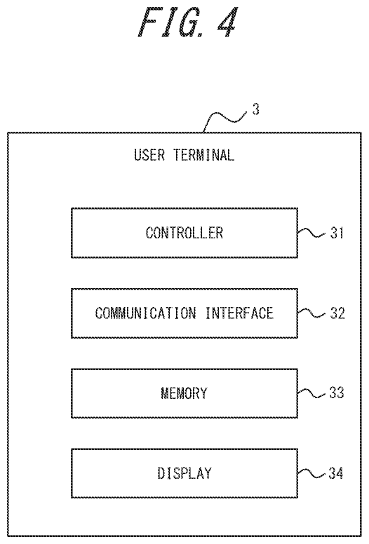

With reference to FIG. 4, an internal configuration of the user terminal 3 will be described in detail.

The user terminal 3 includes a controller 31, a communication interface 32, a memory 33, and a display 34. The components of the user terminal 3 are communicably connected to one another, for example, via dedicated lines.

The hardware configurations of the controller 31, the communication interface 32, and the memory 33 of the user terminal 3 may be the same as those of the controller 21, the communication interface 22, and the memory 23 of the vehicle 2, respectively. An explanation here is omitted.

The display 34 is, for example, a display. The display is, for example, an LCD or an organic EL display. The term “LCD” is an abbreviation of liquid crystal display. The term “EL” is an abbreviation of electro luminescence. The display 34, instead of being included in the user terminal 3, may be connected to the user terminal 3 as an external output device. As a connection method, any technology such as USB, HDMI® (HDMI is a registered trademark in Japan, other countries, or both), or Bluetooth® can be used.

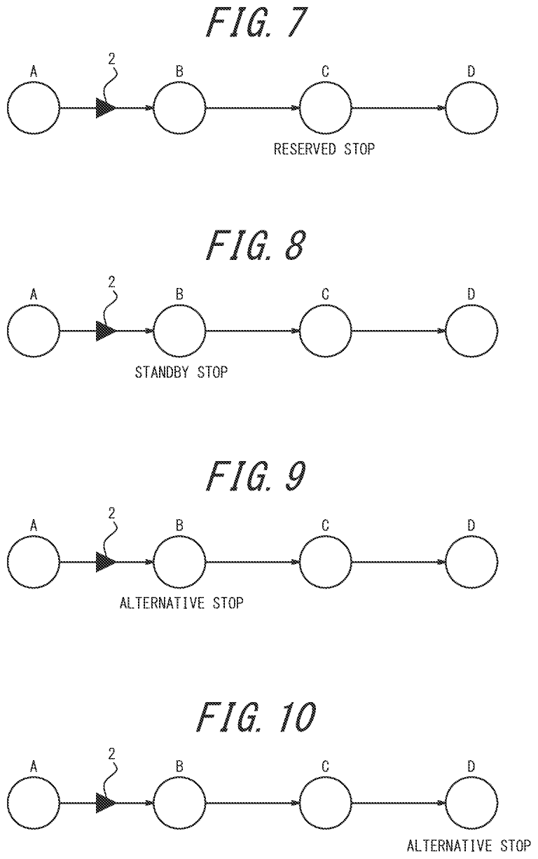

Hereinafter, processing executed by the information processing system S according to the present embodiment will be described in detail. As an example here, on-demand bus service is provided by the vehicle 2. On-demand buses are buses that operate by accepting boarding and alighting reservations from users. A route and stops of the vehicle 2 here are fixed, but may be variable as an alternative example. The stops of the vehicle 2 may be shared with other vehicles such as logistics vehicles, cabs, or general vehicles. When the stops are shared, the second information processing apparatus 4 may accept reservations at the stops. Here, as illustrated in FIG. 7, the vehicle 2, i.e. an automated driving bus is traveling between stops A and B, and is thereafter stopping at at least stops B, C, and D. The stops illustrated in the drawing are just an example. The user P1 operates the user terminal 3 and accesses the information processing apparatus 1 before or after boarding the bus to make an alighting reservation at the stop C. The information processing apparatus 1 accepts the designation of the stop C. The Stop C is referred to as a reserved stop C.

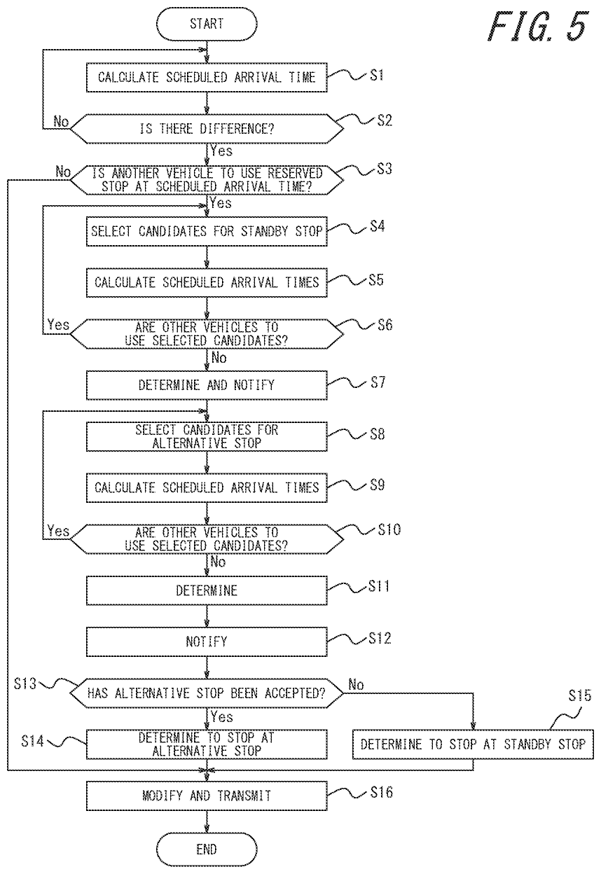

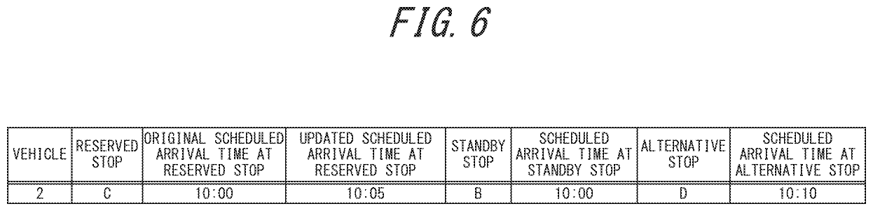

In step S1 of FIG. 5, the controller 11 of the information processing apparatus 1 calculates a scheduled arrival time at the reserved stop C. As illustrated in FIG. 6, the controller 11 stores the scheduled arrival time at the reserved stop C in the memory 13.

In step S2, the controller 11 regularly or irregularly updates the scheduled arrival time at the reserved stop C based on driving records (for example, positional information) of the vehicle 2. The controller 11 stores the updated scheduled arrival time in the memory 13. The controller 11 determines whether there is a difference between the original scheduled arrival time and the updated scheduled arrival time. Step S2 may be optional.

When No in step S2, the controller 11 performs step S1 again.

When Yes in step S2, the controller 11 determines in step S3 whether another vehicle is to use the reserved stop C at the updated scheduled arrival time. This determination may be performed by acquiring operation information from the second information processing apparatus 4 (same below).

When No in step S3, the controller 11 modifies an operation plan so that the vehicle 2 stops at the reserved stop C at the updated scheduled arrival time, and transmits the modified operation plan to the vehicle 2 in step S16. The vehicle 2 travels according to the operation plan. When the vehicle 2 is not an automated driving vehicle, the controller 11 may transmit the modified operation plan to the driver or the like of the vehicle 2.

In step S4, the controller 11 refers to the memory 13, a memory of the second information processing apparatus 4, or the like and selects one or more candidates for a standby stop. The standby stop may be, for example, any of the followings:

The nearest stop from the reserved stop C
A next stop at which the vehicle 2 is stopping, as determined from the current position of the vehicle 2.

The candidates for the standby stop may be selected by a passenger of the vehicle 2.

In step S5, the controller 11 calculates scheduled arrival times at the selected candidates for the standby stop. The calculations may use the driving records or other data on the vehicle 2.

In step S6, the controller 11 determines whether other vehicles are to use the selected candidates at the calculated scheduled arrival times.

When Yes in step S6, the controller 11 performs step S4 again to select another candidate for the standby stop.

When No in step S6, the controller 11 determines in step S7 one of the one or more candidates for the standby stop selected in step S4 as the standby stop, as illustrated in FIG. 8. When a single candidate is selected in step S4, the controller 11 determines the selected single candidate as the standby stop. When multiple candidates are selected in step S4, the controller 11 may request the passenger to select one of the multiple candidates. The request to the passenger may be executed by voice or screen display via the user terminal 3 or the vehicle 2. The passenger here includes all passengers who want to get off at the reserved stop C, but may be part of the passengers as an alternative example. A case in which the stop B is determined as the standby stop will be described here.

The controller 11 notifies the passenger that the vehicle 2 is stopping at the standby stop B. The notification may be performed by voice or screen display via the user terminal 3 or the vehicle 2. The notification may be optional. The vehicle 2 receives a command from the information processing apparatus 1 and travels to the standby stop B.

In step S8, the controller 11 refers to the memory 13 or the like and selects one or more candidates for an alternative stop. As the one or more candidates, stops that meet one or more conditions are selected. The selection may be made at any point in time before or after the vehicle 2 stops at the standby stop B.

As a first condition for the selection, the controller 11 may determine whether a fare constraint is set. The setting may be made by the manager of the vehicle 2 or the user P1. When the fare constraint is set, for example, the controller 11 may select the candidates at which the passenger can get off at a fare equal to or less than a fare to the reserved stop C. When no fare constraint is set, the controller 11 may not consider fares in selecting the candidates. However, even when no fare constraint is set and a candidate requiring a higher fare than the fare to the reserved stop C is selected, the passenger may not be charged any additional cost.

In an alternative or additional example of the first condition, the controller 11 may select any of the following stops as the candidates for the alternative stop, as a second condition:

The nearest stop from the current position of the vehicle 2
A stop at which the vehicle 2 arrives with the smallest difference in time from the scheduled arrival time at the reserved stop C
A stop at which the vehicle 2 arrives with the smallest difference in fare from the fare to the reserved stop C (this candidate may be selected only when there is no fare constraint in the first condition above).

When the vehicle 2 is shared by the multiple passengers, the controller 11 may, in an alternative or additional example of the first and second conditions, select the candidates for the alternative stop from any of the followings:

A stop beyond (ahead of) or before the reserved stop C
A stop before the reserved stop C (in this case, a stop beyond the reserved stop C is not included in the candidates)
A stop beyond the reserved stop C (in this case, a stop before the reserved stop C is not included in the candidates).

Whether the vehicle 2 is shared may be determined from a reservation history of the vehicle 2 or positional information on each passenger.

In step S9, the controller 11 calculates scheduled arrival times at the candidates for the alternative stop.

At step S10, the controller 11 determines whether other vehicles are to use the candidates for the alternative stop at the calculated scheduled arrival times.

When Yes in step S10, the controller 11 performs step S8 again to select another candidate.

When No in step S10, the controller 11 determines, in step S11, one of the candidates selected in step S8, as the alternative stop. When a single candidate is selected in step S8, the controller 11 determines the selected single candidate as the standby stop. When multiple candidates are selected in step S8, the controller 11 may request the passenger to select one of the multiple candidates. FIG. 9 illustrates an example of a case in which the stop B, before the reserved stop C, is determined as the alternative stop. FIG. 10 illustrates an example of a case in which the stop D, beyond the reserved stop C, is determined as the alternative stop.

FIG. 6 illustrates an example of a data structure of a scheduled arrival time DB when the stop C is set as the reserved stop, the stop B is set as the standby stop, and the stop D is set as the alternative stop. Times listed in FIG. 6 are for the same day.

In step S12, the controller 11 notifies the passenger that the vehicle 2 is stopping at the determined alternative stop. In an additional or alternative example, the controller 11 may notify the passenger that the passenger can get off at the alternative stop by pressing the exit button 24.

In step S13, the controller 11 determines whether the alternative stop has been accepted by the passenger. For example, the controller 11 may notify the user terminal 3 of the alternative stop to request acceptance on the user terminal 3.

For example, when the vehicle 2 is shared by multiple passengers, there may be a passenger who wants to get off before the reserved stop C and a passenger who wants to get off beyond the reserved stop C. In this case, the operation plan would be inconsistent. Thus, when the stop D beyond the reserved stop C is determined as the alternative stop, the controller 11 determines whether the determined stop D has been accepted by all the passengers in the vehicle 2.

When No in step S13, the controller 11 determines in step S15 to stop the vehicle 2 at the standby stop B, as illustrated in FIG. 9.

When Yes in step S13, the controller 11 determines in step S14 to stop the vehicle 2 at the alternative stop D.

Steps S13 to S15 are optional.

In step S16, the controller 11 modifies the operation plan and transmits the operation plan to the vehicle 2 so that the vehicle 2 operates as determined in step S14 or S15. The vehicle 2 travels according to the operation plan. When the vehicle 2 is not an automated driving vehicle, the controller 11 may transmit the modified operation plan to the manager or driver of the vehicle 2.

According to the present embodiment, as described above, the controller 11 of the information processing apparatus 1 is configured to execute operations that include accepting designation of a reserved stop C as a stop for the vehicle 2, determining a stop other than the reserved stop C as a standby stop B when it is determined that the reserved stop C is to be used by another vehicle at a scheduled arrival time at the reserved stop C, and notifying a passenger of the vehicle 2 that the vehicle 2 is stopping at the standby stop B. The operations of the controller 11 include determining, as the standby stop, the nearest stop from the reserved stop C or a next stop at which the vehicle 2 is stopping. According to this configuration, the information processing apparatus 1 allows the vehicle 2 to avoid stopping at the reserved stop C when the reserved stop C is congested, thus smoothing traffic. The information processing apparatus 1 also allows the passenger to get off at the standby stop B, thus improving service convenience.

According to the present embodiment, the operations of the controller 11 also include determining a stop meeting one or more conditions, as an alternative stop at which the vehicle 2 stops in place of the reserved stop C. The one or more conditions include the condition that a fare to the alternative stop is equal to or less than a fare to the reservation stop C, the condition that the alternative stop is the nearest stop from the reservation stop C, and the condition that the difference between the fare to the alternative stop and the fare to the reserved stop C is minimal. This configuration allows the information processing apparatus 1 to have an increased number of stop options for passengers to get off, thus further improving service convenience.

According to the present embodiment, the operations of the controller 11 include, in a case in which the vehicle 2 is shared by multiple passengers and the multiple passengers are notified of a stop beyond the reserved stop C as the alternative stop, determining to stop the vehicle 2 at the alternative stop when the stop beyond the reserved stop is accepted by the multiple passengers, and determining to stop the vehicle 2 at the standby stop B when the stop beyond the reserved stop is not accepted by the multiple passengers. According to this configuration, the information processing apparatus 1 can reduce inconsistency occurring in the operation plan, even when there are a passenger who wants to get off before the reserved stop C and a passenger who wants to get off beyond the reserved stop C.

While the present disclosure has been described with reference to the drawings and examples, it should be noted that various modifications and revisions may be implemented by those skilled in the art based on the present disclosure. Other modifications can be made without departing from the spirit of the present disclosure. For example, functions or the like included in each means or each step can be rearranged without logical inconsistency, and a plurality of means or steps can be combined into one or divided.

For example, in the aforementioned embodiment, a program configured to execute all or some of the functions or processing of the information processing apparatus 1 can be recorded on a computer readable recording medium. The computer readable recording medium includes a non-transitory computer readable medium and is, for example, a magnetic recording apparatus, an optical disc, a magneto-optical recording medium, or a semiconductor memory. The program is distributed, for example, by selling, transferring, or lending a portable recording medium such as a Digital Versatile Disc (DVD) or a Compact Disc Read Only Memory (CD-ROM) on which the program is recorded. The program may also be distributed by storing the program in a storage of any server and transmitting the program from any server to another computer. The program may be provided as a program product. The present disclosure can also be implemented as a program executable by a processor.

The computer temporarily stores in a main memory, for example, a program recorded on a portable recording medium, or a program transferred from a server. Then, the computer reads the program stored in the main memory using a processor, and executes processes in accordance with the read program using the processor. The computer may read a program directly from the portable recording medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

1. An information processing apparatus comprising a controller configured to execute operations, the operations comprising:
accepting designation of a reserved stop as a stop for a vehicle;
determining a stop other than the reserved stop as a standby stop when it is determined that the reserved stop is to be used by another vehicle at a scheduled arrival time at the reserved stop; and
notifying a passenger of the vehicle that the vehicle is stopping at the standby stop.

2. The information processing apparatus according to claim 1, wherein the operations comprise determining, as the standby stop, a nearest stop from the reserved stop or a next stop at which the vehicle is stopping.

3. The information processing apparatus according to claim 1, wherein the operations comprise determining a stop meeting one or more conditions, as an alternative stop at which the vehicle is stopping in place of the reserved stop.

4. The information processing apparatus according to claim 3, wherein the one or more conditions include a condition that a fare to the alternative stop is equal to or less than a fare to the reserved stop.

5. The information processing apparatus according to claim 3, wherein the one or more conditions include a condition that the alternative stop is a nearest stop from the reserved stop.

6. The information processing apparatus according to claim 3, wherein the one or more conditions include a condition that a difference between a fare to the alternative stop and a fare to the reserved stop is minimal.

7. The information processing apparatus according to claim 3, wherein the operations comprise,
in a case in which the vehicle is shared by multiple passengers and the multiple passengers are notified of a stop beyond the reserved stop as the alternative stop,
determining to stop the vehicle at the alternative stop when the stop beyond the reserved stop is accepted by the multiple passengers, and determining to stop the vehicle at the standby stop when the stop beyond the reserved stop is not accepted by the multiple passengers.

8. A vehicle having the information processing apparatus according to claim 1 mounted therein.

9. A non-transitory computer readable medium storing a program configured to cause a computer, as an information processing apparatus, to execute operations, the operations comprising:
accepting designation of a reserved stop as a stop for a vehicle;
determining a stop other than the reserved stop as a standby stop when it is determined that the reserved stop is to be used by another vehicle at a scheduled arrival time at the reserved stop; and
notifying a passenger of the vehicle that the vehicle is stopping at the standby stop.

10. The non-transitory computer readable medium according to claim 9, wherein the operations comprise determining, as the standby stop, a nearest stop from the reserved stop or a next stop at which the vehicle is stopping.

11. The non-transitory computer readable medium according to claim 9, wherein the operations comprise determining a stop meeting one or more conditions, as an alternative stop at which the vehicle is stopping in place of the reserved stop.

12. The non-transitory computer readable medium according to claim 11, wherein the one or more conditions include a condition that a fare to the alternative stop is equal to or less than a fare to the reserved stop.

13. The non-transitory computer readable medium according to claim 11, wherein the one or more conditions include a condition that the alternative stop is a nearest stop from the reserved stop.

14. The non-transitory computer readable medium according to claim 11, wherein the one or more conditions include a condition that a difference between a fare to the alternative stop and a fare to the reserved stop is minimal.

15. An information processing method performed by an information processing apparatus, the information processing method comprising:
accepting designation of a reserved stop as a stop for a vehicle;
determining a stop other than the reserved stop as a standby stop when it is determined that the reserved stop is to be used by another vehicle at a scheduled arrival time at the reserved stop; and
notifying a passenger of the vehicle that the vehicle is stopping at the standby stop.

16. The information processing method according to claim 15, comprising determining, as the standby stop, a nearest stop from the reserved stop or a next stop at which the vehicle is stopping.

17. The information processing method according to claim 15, comprising determining a stop meeting one or more conditions, as an alternative stop at which the vehicle is stopping in place of the reserved stop.

18. The information processing method according to claim 17, wherein the one or more conditions include a condition that a fare to the alternative stop is equal to or less than a fare to the reserved stop.

19. The information processing method according to claim 17, wherein the one or more conditions include a condition that the alternative stop is a nearest stop from the reserved stop.

20. The information processing method according to claim 17, wherein the one or more conditions include a condition that a difference between a fare to the alternative stop and a fare to the reserved stop is minimal.
